(19) United States
(12) Patent Application Publication
(10) Pub. No.: US 2026/0226742 A1
(43) Pub. Date: Aug. 6, 2026

(54) FIBRE FOR CONCRETE REINFORCEMENT WITH CROSS DEFORMATION

(71) Applicant: OPTIMET CONCRETE PRODUCTS INC., Toronto (CA)

(72) Inventor: Paul LAFONTAINE, Barrington, IL (US)

(21) Appl. No.: 19/152,992

(22) PCT Filed: Feb. 26, 2024
(86) PCT No.: PCT/CA2024/000002

§ 371 Date: Aug. 1, 2025

Related U.S. Application Data
(60) Provisional application No. 63/448,457, filed on Feb. 27, 2023.

(51) Int. Cl. E04C 5/07; C04B 14/38

(52) U.S. Cl. CPC E04C 5/073; C04B 14/38

(57) ABSTRACT

A fibre for concrete reinforcement. The fibre has an elongated body with a first end section, a middle section, and a second end section. The first end section and the second end section each have a sinusoidal shape, and both lie in a common plane and are bisected by the common plane. The first end section and the second end section each have a deformed portion and an undeformed portion. The lateral width of the deformed portion is greater than the lateral width of the undeformed portion, the lateral width being measured perpendicularly to the common plane.

### RELATED APPLICATION

This application claims priority to and the benefit of 35 USC § 119(e) to U.S. Patent Application Ser. No. 63/448457, filed Feb. 27, 2023, the entirety of which is incorporated herein by reference.

### FIELD OF THE INVENTION

The present invention relates to concrete reinforcing members that are mixed into concrete to enhance the toughness and energy absorption capacity thereof.

### BACKGROUND OF THE INVENTION

Concrete is a relatively brittle material that exhibits poor tensile strength. A known way to enhance the toughness and energy absorption capacity of concrete is to disperse short fibers, often made from steel, throughout the concrete. The fibers are typically provided with one or more deformations that allow them to more effectively anchor in the cement matrix.

U.S. Pat. No. 5,443,918 to Banthia et al., which is incorporated herein by reference, discloses a concrete reinforcing fiber with sinusoid shaped end portions.

### SUMMARY OF THE INVENTION

In one aspect the present invention provides a fibre for concrete reinforcement, the fibre having an elongated body with a first end section, a middle section, and a second end section. The first end section and the second end section each have a sinusoidal shape, and both lie in a common plane and are bisected by the common plane. The first end section and the second end section each have a deformed portion and an undeformed portion. The lateral width of the deformed portion is greater than the lateral width of the undeformed portion, the lateral width being measured perpendicularly to the common plane.

The inventor has appreciated that the performance of a fibre having sinusoidal end portions can be improved by adding a deformation to the end portions in a direction that is perpendicular to the plane of the sine wave.

In preferred embodiments of the invention, the deformations each extend along axes that are different from and nonparallel to each other, as well as being different from and nonparallel to the longitudinal axis of the fibre. The inventor has appreciated that having deformations that extend in different axes can further improve the performance of the fibre.

Further aspects of the invention include:
1. A fibre for concrete reinforcement, which optionally incorporates one or more features of one or more of the following and/or preceding aspects, comprising: an elongated body having a first end section, a middle section, and a second end section; wherein the first end section and the second end section each have a sinusoidal shape; wherein the first end section and the second end section both lie in a common plane and are bisected by the common plane; wherein the first end section and the second end section each have a lateral width that is measured perpendicularly to the common plane; wherein the first end section and the second end section each have a deformed portion and an undeformed portion; and wherein the lateral width of the deformed portion is greater than the lateral width of the undeformed portion.
2. A fibre for concrete reinforcement, which optionally incorporates one or more features of one or more of the following and/or preceding aspects, wherein the middle section extends linearly along a longitudinal axis; wherein the deformed portion of the first end section extends from a first deformation start point to a first deformation end point; wherein a first deformation axis passes through the first deformation start point and the first deformation end point; and wherein the first deformation axis differs from the longitudinal axis and is nonparallel to the longitudinal axis.
3. A fibre for concrete reinforcement, which optionally incorporates one or more features of one or more of the following and/or preceding aspects, wherein the deformed portion of the second end section extends from a second deformation start point to a second deformation end point; wherein a second deformation axis passes through the second deformation start point and the second deformation end point; and wherein the second deformation axis differs from the longitudinal axis and is nonparallel to the longitudinal axis.
4. A fibre for concrete reinforcement, which optionally incorporates one or more features of one or more of the following and/or preceding aspects, wherein the first deformation axis differs from the second deformation axis and is nonparallel to the second deformation axis.
5. A fibre for concrete reinforcement, which optionally incorporates one or more features of one or more of the following and/or preceding aspects, wherein the undeformed portion of the first end section comprises a first end of the elongated body; wherein the undeformed portion of the second end section comprises a second end of the elongated body; wherein the deformed portion of the first end section is spaced from the first end; and wherein the deformed portion of the second end section is spaced from the second end.
6. A fibre for concrete reinforcement, which optionally incorporates one or more features of one or more of the following and/or preceding aspects, wherein the deformed portion of the first end section is spaced at least 1 mm from the first end; and wherein the deformed portion of the second end section is spaced at least 1 mm from the second end.
7. A fibre for concrete reinforcement, which optionally incorporates one or more features of one or more of the following and/or preceding aspects, wherein the deformed portion of the first end section is spaced about 2 mm from the first end; and wherein the deformed portion of the second end section is spaced about 2 mm from the second end.
8. A fibre for concrete reinforcement, which optionally incorporates one or more features of one or more of the following and/or preceding aspects, wherein the deformed portion of the first end section and the deformed portion of the second end section each have a length of at least 2 mm.
9. A fibre for concrete reinforcement, which optionally incorporates one or more features of one or more of the following and/or preceding aspects, wherein the deformed portion of the first end section and the deformed portion of the second end section each have a length of about 4 mm.
10. A fibre for concrete reinforcement, which optionally incorporates one or more features of one or more of the following and/or preceding aspects, wherein the fibre has a length of about 60 mm.
11. A fibre for concrete reinforcement, which optionally incorporates one or more features of one or more of the following and/or preceding aspects, wherein the first end section and the second end section each have a length of at least 6 mm.
12. A fibre for concrete reinforcement, which optionally incorporates one or more features of one or more of the following and/or preceding aspects, wherein the first end section and the second end section each have a length of about 12 mm.
13. A fibre for concrete reinforcement, which optionally incorporates one or more features of one or more of the following and/or preceding aspects, wherein the first end section is about ⅕ of a total length of the elongated body; wherein the middle section is about ⅗ of the total length of the elongated body; and wherein the second end section is about ⅕ of the total length of the elongated body.
14. A fibre for concrete reinforcement, which optionally incorporates one or more features of one or more of the following and/or preceding aspects, wherein the lateral width of the deformed portion is between 30% and 80% greater than the lateral width of the undeformed portion.
15. A fibre for concrete reinforcement, which optionally incorporates one or more features of one or more of the following and/or preceding aspects, wherein a cross-sectional height of the undeformed portion is greater than the cross-sectional height of the deformed portion.
16. A fibre for concrete reinforcement, which optionally incorporates one or more features of one or more of the following and/or preceding aspects, wherein the middle section and the undeformed portions of the first end section and the second end section have a first cross-sectional shape; wherein the deformed portions of the first end section and the second end section have a second cross-sectional shape; and wherein the first cross-sectional shape is different than the second cross-sectional shape.
17. A fibre for concrete reinforcement, which optionally incorporates one or more features of one or more of the following and/or preceding aspects, wherein the first cross-sectional shape comprises a circle, an ellipse, a square, or a rectangle.
18. A fibre for concrete reinforcement, which optionally incorporates one or more features of one or more of the following and/or preceding aspects, wherein the first cross-sectional shape comprises a circle and the second cross-sectional shape comprises an ellipse.
19. A fibre for concrete reinforcement, which optionally incorporates one or more features of one or more of the following and/or preceding aspects, wherein the first end section and the second end section each extend for a single sinusoidal wavelength, including one peak and one trough.
20. A fibre for concrete reinforcement, which optionally incorporates one or more features of one or more of the following and/or preceding aspects, wherein the first end section and the second end section each have a wave amplitude that is about 1/6 of the wavelength.

### BRIEF DESCRIPTION OF THE DRAWINGS

Further aspects and advantages of the invention will appear from the following description taken together with the accompanying drawings, in which:

FIG. 1 shows A) a side view, B) a top view, and C) cross sectional views of a fibre in accordance with an embodiment of the present invention.

### DETAILED DESCRIPTION OF THE DRAWINGS

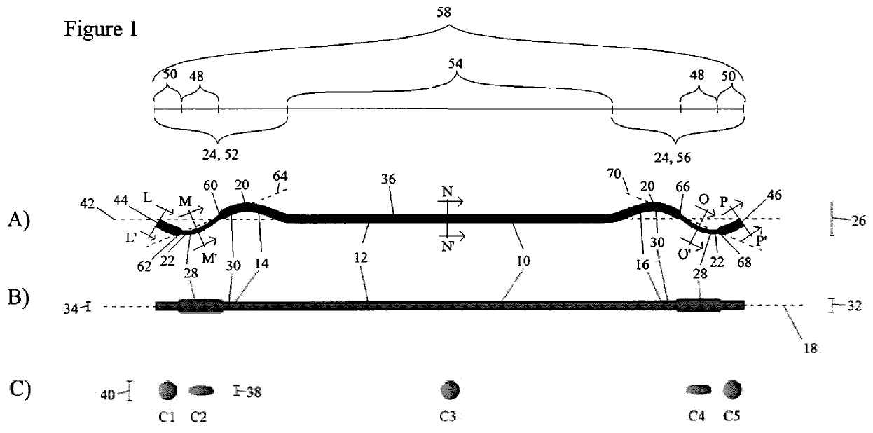

FIG. 1 shows a concrete reinforcing fibre 10 in accordance with a preferred embodiment of the present invention. As can be seen in FIG. 1, the fibre 10 has an elongated body 36 including a linear middle section 12, a first sinusoidal end section 14, and a second sinusoidal end section 16. The middle section 12 extends linearly along a longitudinal axis 42. Each end section 14, 16 has a sine wave-like shape. The sine waves lie in a common plane 18, such that the sine waves are visible when viewed from the side (as shown in view A) but not visible when viewed from above (as shown in view B).

In the embodiment shown, each end section 14, 16 has a single wave, which extends upwardly from the middle section 12 towards a peak 20, and then extends downwardly towards a trough 22, before raising upwardly again to a midpoint at a height between the trough 22 and the peak 20. In the embodiment shown, the sine wave has a wavelength 24 of about 12 mm and an amplitude 26 of about 2 mm. In alternative embodiments, the sine wave could have a different number of waves, a different wavelength 24, and/or a different amplitude 26.

As can be seen in FIG. 1, each end section 14, 16 has a deformed portion 28 and an undeformed portion 30. Referring to view B, it can be seen that the deformed portion 28 has a lateral width 32 that is greater than the lateral width 34 of the undeformed portion 30.

The relative shapes of the deformed portion 28 and the undeformed portion 30 can be further understood with reference to the cross sectional views C1, C2, C3, C4, and C5. Cross-sectional view Cl is taken along line L-L′; cross-sectional view C2 is taken along line M-M′; cross-sectional view C3 is taken along line N-N′; cross-sectional view C4 is taken along line O-O′; and cross-sectional view C5 is taken along line P-P′.

As can be seen in views C1 and C2, the undeformed portion 30 of the first end section 14 has a circular cross-sectional shape, and the deformed portion 28 of the first end section 14 has an oval or elliptical shape. The deformed portion 28 may be formed, for example, by forcefully pinching the fibre 10 in order to deform the fibre 10 from a circular cross-sectional shape to an oval or elliptical cross-sectional shape. As can be seen by comparing views C1 and C2, the deformed portion 28 has a height 38 that is less than the height 40 of the undeformed portion 30. In other embodiments of the invention, different cross-sectional shapes could be used.

The deformed portions 28 are preferably spaced from the ends 44, 46 of the fibre 10. In the embodiment shown, the deformed portions 28 each have a longitudinal length 48 of about 4 mm, and are located at a longitudinal distance 50 of about 2 mm from the ends 44, 46 of the fibre 10. In some embodiments, the deformed portions 28 may have a length 48 greater than 4 mm, and may be spaced between 1 and 12 mm from the ends 44, 46 of the fibre 10. In the embodiment shown, the first end section 14 has a length 52 of about 12 mm; the middle section 12 has a length 54 of about 36 mm; the second end section 16 has a length 56 of about 12 mm; and the entire fibre 10 has a length of about 60 mm. In other embodiments of the invention, different dimensions could be used.

In the embodiment shown, the deformed portions 28 are located in the portion of the sine wave that extends from approximately the midpoint after the peak 20 down to approximately the bottom of the trough 22. More specifically, the deformed portion 28 of the first end section 14 extends from a first deformation start point 60 to a first deformation end point 62. A first deformation axis 64 passes through the first deformation start point 60 and the first deformation end point 62. The first deformation axis 64 is different from and nonparallel to the longitudinal axis 42.

Similarly, the deformed portion 28 of the second end section 16 extends from a second deformation start point 66 to a second deformation end point 68, with a second deformation axis 70 passing through the second deformation start point 66 and the second deformation end point 68. The second deformation axis 70 is different from and nonparallel to both the longitudinal axis 42 and the first deformation axis 64. In other embodiments of the invention, the deformed portions 28 could be located at different portions of the sine wave.

The fibre 10 is preferably made from steel, though other suitable materials could be used as well. Suitable materials may include stainless steel, high tensile steel wire, and non-ferrous materials including polymeric materials.

It will be understood that, although various features of the invention have been described with respect to one or another of the embodiments of the invention, the various features and embodiments of the invention may be combined or used in conjunction with other features and embodiments of the invention as described and illustrated herein.

All lengths referred to herein are measured along the longitudinal axis 42. The cross-sections referred to herein are taken along lines that are perpendicular to the curve of the fibre 10 (i.e. perpendicular to the tangent line at a given point along the fibre 10). The cross-sectional heights are measured perpendicularly to the lateral widths.

The invention is not limited to the particular dimensions disclosed. In some embodiments of the invention, the fibre 10 may have a length of 30 mm or more; 40 mm or more; 50 mm or more; 60 mm or more; 70 mm or more; 80 mm or more; 90 mm or more; 100 mm or more; or between 30 mm and 100 mm. In some embodiments of the invention, the first end section 12 and the second end section 14 may each have a longitudinal length that is 1/10 or more of the total length of the fibre 10; ⅛ or more of the total length of the fibre; ⅙ or more of the total length of the fibre 10; ⅕ or more of the total length of the fibre 10; ¼ or more of the total length of the fibre 10; ⅓ or more of the total length of the fibre 10; or between 1/10 and ⅓ of the total length of the fibre 10. In some embodiments of the invention the wavelength of the sine wave may be 1/10 or more of the total length of the fibre 10; ⅛ or more of the total length of the fibre; ⅙ or more of the total length of the fibre 10; ⅕ or more of the total length of the fibre 10; ¼ or more of the total length of the fibre 10; ⅓ or more of the total length of the fibre 10; or between 1/10 and ⅓ of the total length of the fibre 10. In some embodiments of the invention the amplitude of the sine wave may be 1/10 or more of the wavelength; ⅛ or more of the wavelength; ⅙ or more of the wavelength; ¼ or more of the wavelength; ½ or more of the wavelength; or between ⅛ and ¼ of the wavelength. In some embodiments of the invention, the undeformed portion 30 of the fibre 10 may have a lateral width of 3 mm or less; 2 mm or less; 1 mm or less; about 1 mm; about 0.5 mm; or between about 2 mm and about 0.5 mm. In some embodiments of the invention, the deformed portion 28 of the fibre 10 may have a lateral width that is 20% or more greater than the lateral width of the undeformed portion 30; 30% or more greater than the lateral width of the undeformed portion 30; 40% or more greater than the lateral width of the undeformed portion 30; 50% or more greater than the lateral width of the undeformed portion 30; 60% or more greater than the lateral width of the undeformed portion 30; 70% or more greater than the lateral width of the undeformed portion 30; or between 30% and 80% greater than the lateral width of the undeformed portion 30. In some embodiments of the invention, the deformed portion 28 of the fibre 10 may have a cross-sectional height that is at least 20% lower than the cross-sectional height of the undeformed portion 30; at least 30% lower than the cross-sectional height of the undeformed portion 30; at least 40% lower than the cross-sectional height of the undeformed portion 30; at least 50% lower than the cross-sectional height of the undeformed portion 30; at least 60% lower than the cross-sectional height of the undeformed portion 30; at least 70% lower than the cross-sectional height of the undeformed portion 30; or between 30% and 80% lower than the cross-sectional height of the undeformed portion 30. In some embodiments of the invention, each end section 14, 16 extends for at least one wavelength of the sine wave; for about 1 wavelength of the sine wave; or for between about 1 wavelength and about 3 wavelengths. In some embodiments of the invention, the first end section 14 is a mirror image of the second end section 16.

Although this disclosure has described and illustrated certain preferred embodiments of the invention, it is to be understood that the invention is not restricted to these particular embodiments. Rather, the invention includes all embodiments which are functional or mechanical equivalents of the specific embodiments and features that have been described and illustrated herein.

1. A fibre for concrete reinforcement comprising:
an elongated body having a first end section, a middle section, and a second end section;
wherein the first end section and the second end section each have a sinusoidal shape;
wherein the first end section and the second end section both lie in a common plane and are bisected by the common plane;
wherein the first end section and the second end section each have a lateral width that is measured perpendicularly to the common plane;
wherein the first end section and the second end section each have a deformed portion and an undeformed portion; and
wherein the lateral width of the deformed portion is greater than the lateral width of the undeformed portion.

2. The fibre according to claim 1, wherein the middle section extends linearly along a longitudinal axis;
wherein the deformed portion of the first end section extends from a first deformation start point to a first deformation end point;
wherein a first deformation axis passes through the first deformation start point and the first deformation end point; and
wherein the first deformation axis differs from the longitudinal axis and is nonparallel to the longitudinal axis.

3. The fibre according to claim 2,
wherein the deformed portion of the second end section extends from a second deformation start point to a second deformation end point;
wherein a second deformation axis passes through the second deformation start point and the second deformation end point; and
wherein the second deformation axis differs from the longitudinal axis and is nonparallel to the longitudinal axis.

4. The fibre according to claim 3,
wherein the first deformation axis differs from the second deformation axis and is nonparallel to the second deformation axis.

5. The fibre according to claim 1 , wherein the undeformed portion of the first end section comprises a first end of the elongated body;
wherein the undeformed portion of the second end section comprises a second end of the elongated body;
wherein the deformed portion of the first end section is spaced from the first end; and
wherein the deformed portion of the second end section is spaced from the second end.

6. The fibre according to claim 5, wherein the deformed portion of the first end section is spaced at least 1 mm from the first end; and
wherein the deformed portion of the second end section is spaced at least 1 mm from the second end.

7. The fibre according to claim 5, wherein the deformed portion of the first end section is spaced about 2 mm from the first end; and
wherein the deformed portion of the second end section is spaced about 2 mm from the second end.

8. The fibre according to claim 1, wherein the deformed portion of the first end section and the deformed portion of the second end section each have a length of at least 2 mm.

9. The fibre according to claim 1, wherein the deformed portion of the first end section and the deformed portion of the second end section each have a length of about 4 mm.

10. The fibre according to claim 1, wherein the fibre has a length of about 60 mm.

11. The fibre according to claim 1, wherein the first end section and the second end section each have a length of at least 6 mm.

12. The fibre according to claim 1, wherein the first end section and the second end section each have a length of about 12 mm.

13. The fibre according to claim 1, wherein the first end section is about ⅕ of a total length of the elongated body;
wherein the middle section is about ⅗ of the total length of the elongated body; and
wherein the second end section is about ⅕ of the total length of the elongated body.

14. The fibre according to claim 1, wherein the lateral width of the deformed portion is between 30% and 80% greater than the lateral width of the undeformed portion.

15. The fibre according to claim 1, wherein a cross-sectional height of the undeformed portion is greater than the cross-sectional height of the deformed portion.

16. The fibre according to claim 1, wherein the middle section and the undeformed portions of the first end section and the second end section have a first cross-sectional shape;
wherein the deformed portions of the first end section and the second end section have a second cross-sectional shape; and
wherein the first cross-sectional shape is different than the second cross-sectional shape.

17. The fibre according to claim 16, wherein the first cross-sectional shape comprises a circle, an ellipse, a square, or a rectangle.

18. The fibre according to claim 16, wherein the first cross-sectional shape comprises a circle and the second cross-sectional shape comprises an ellipse.

19. The fibre according to claim 1, wherein the first end section and the second end section each extend for a single sinusoidal wavelength, including one peak and one trough.

20. The fibre according to claim 19, wherein the first end section and the second end section each have a wave amplitude that is about ⅙ of the wavelength.
